(19) United States
(12) Patent Application Publication
(10) Pub. No.: US 2011/0018680 A1
(43) Pub. Date: Jan. 27, 2011

(54) SECURITY SYSTEM WITH POWER SAVING FEATURE AND METHOD THEREOF

(76) Inventors: CHIN-LUN LAI, Taipei (TW); LI-SHIH LIAO, Taipei (TW); HAI-CHOU TIEN, Taipei (TW); CHIN-DING LAI, Taipei (TW)

Correspondence Address: KILE PARK GOEKJIAN REED & MCMANUS, 1200 NEW HAMPSHIRE AVE, NW, SUITE 570, WASHINGTON, DC, 20036, US

(21) Appl. No.: 12/835,712

(22) Filed: Jul. 13, 2010

(30) Foreign Application Priority Data
Jul. 27, 2009 (TW) 98125259

(51) Int. Cl. G05B 23/02

(52) U.S. Cl. 340/3.1

(57) ABSTRACT

A security system with power saving feature includes an electromagnetic lock and a sensing module. The electromagnetic lock is for receiving a limited supply of an electric power supplied by a power supply circuit before a full supply of the electric power is delivered to the electromagnetic lock. The sensing module may cause the full supply of the electric power upon sensing a specific action signal caused by an environment change. Therefore, the electromagnetic lock may operate in a lock state with only the limited supply of the electric power and still operate in the same lock state even after the generation of the triggering signal. Thus, the time during which the electromagnetic lock operates with the full supply of the electric power is minimized, limiting the total power consumption accordingly.

### BACKGROUND OF THE INVENTION

1. Field of the Invention

The present invention relates to a security system, and more particularly, to a security system with power saving feature and method thereof.

2. Description of Related Art

In security industries or products (e.g., access control system), electromagnetic locks have been widely utilized. The conventional security system is required to uninterruptedly supply an electric power to the electromagnetic lock in order to generate a sufficient electromagnetic field for the electromagnetic lock to remain in a tight attachment onto an iron plate. As such, the iron plate could be placed in a “lock” state. On the other hand, when the iron plate is to be unlocked the electric power supplied to the electromagnetic lock may need to be stopped. However, the power consumed by an electromagnetic lock driven by a general direct current (DC) power supply may range from about several Watts (W) to roughly tens of Watts; in case of 12 Volts (V) DC power supply, it will continuously consume a current of hundreds of milliamperes (mA) for the electromagnetic lock to properly operate. Therefore, the necessity of the continuous supply of the electric power for the conventional security system would leave the performance of the power consumption of the conventional security system a lot to be desired.

In response to the aforementioned unnecessary power consumption, other conventional security systems are configured to enter into a standby mode in which less power would be consumed. And such systems would operate normally once after awaken by a remote control. Thus, the total power consumption could be reduced. However, since the conventional security systems are unable to respond to any triggering event (e.g., access to the room behind the iron plate) immediately when operating in the standby mode the conventional security systems fail to meet the requirement of prompt response to the triggering event. Besides, as manual operation is necessary for these conventional security systems to switch from the standby mode the goal of automatic control for the access may not be achieved.

### SUMMARY OF THE INVENTION

In view of the aforementioned issues, the technical problem that the present invention aims to resolve is to provide a security system meeting the requirements on both energy-saving and functional controls, allowing the security system to stay in a state requiring low power consumption, detecting any request for access by means of a sensing module, and thus controlling the locking/unlocking in the electromagnetic lock. In this way, the features of power saving as well as automatic prompt response to a triggering event can be achieved.

To resolve the above-mentioned issues, a security system with power saving feature according to an embodiment of the present invention is provided. The security system includes an electromagnetic lock and a sensing module. The electromagnetic lock is used for receiving an electric power supplied by a power supply circuit when the electromagnetic lock is to enter into a lock state. The sensing module is configured to cause the power supply circuit to supply a maintaining current to the electromagnetic lock so that the electromagnetic lock could stay in the lock state to start with, and output a triggering signal to enable the full supply of the electric power to the electromagnetic lock when sensing a specific action signal caused by an environment change. Consequently, the electromagnetic lock may consume less power before any triggering event takes place.

To resolve the above-mentioned issues, a method for operating a security system having an electromagnetic lock is provided. The method includes starting the security monitoring system and entering the security system into a power saving mode in which a maintaining current is provided with the electromagnetic lock, and causing the sensing module to output a triggering signal based on a specific action signal caused by an environment change so as to wake up the security monitoring system to operate in an operation mode in which the full supply of electric power is delivered to the electromagnetic lock.

The aforementioned Summary as well as the Detailed Descriptions and appended Drawings set forth hereinafter are all for further illustrating the approaches, means and effects taken by the present invention for successfully achieving the predetermined objectives. Other goals and advantages relating to the present invention will be also explained in the subsequent texts and diagrams.

### BRIEF DESCRIPTION OF THE DRAWINGS

FIG. 1 is a block diagram for an embodiment of the security system with power saving feature according to the present invention;

FIG. 2 is a flowchart illustrating an operating method for the security system shown in FIG. 1 according to the present invention;

FIG. 3 is a schematic diagram illustrating the security system according to one embodiment of the present invention;

FIG. 4 is a schematic diagram illustrating the security monitoring system according to another embodiment of the present invention;

FIG. 5 is a schematic diagram illustrating the security system according to another embodiment of the present invention;

FIG. 6A is a schematic diagram illustrating a security system according to another embodiment of the present invention; and

FIG. 6B is a schematic diagram illustrating a security system according to another embodiment of the present invention.

### DETAILED DESCRIPTION OF THE PREFERRED EMBODIMENTS

The present invention provides a security system with power saving feature and method thereof. More specifically, the present invention security system is configured to detect if there is any request for access before the full supply of electric power to the electromagnetic lock. Typically, the security system is applied to an access control systems, and an emergency doorway that is capable of allowing the passages of persons or goods when necessary. By means of the design disclosed herein, it is possible to allow the electromagnetic lock in the security system to remain in a lock state with limited power consumption; but, in case that a user approaches to or intends to pass through the monitored passage, then the security system immediately responds and supplies the required power (e.g., the full power supply) to the electromagnetic lock so that the electromagnetic lock could continue to operate in the lock state. Thus the requirements on both power saving and automatic control can be effectively met.

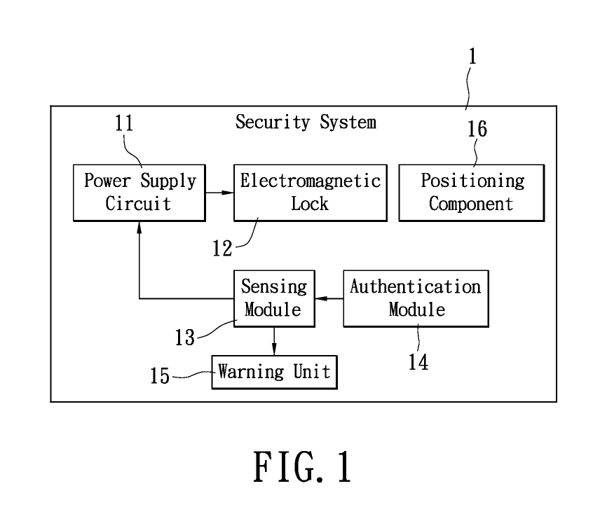

Refer to FIG. 1, wherein a block diagram for an embodiment of the security system with power saving feature according to the present invention is shown. As shown in FIG. 1, the present embodiment provides a security system 1 comprising a power supply circuit 11, an electromagnetic lock 12, a sensing module 13 and an authentication module 14. Herein the power supply circuit 11 is used to receive the triggering signal associated with the triggering event and provide the required power supply with the security system 1 for the security system 1 to operate. In one implementation, the power supply circuit 11 may be an Uninterruptible Power Supply (UPS) so that the security system 1 may be operable at any time and under any possible circumstances.

The electromagnetic lock 12 is electrically coupled to the power supply circuit 11, and is configured to receive the electric power from the power supply circuit 11 for remaining in a lock state. Besides, for those skilled ones in the art, it is appreciable that the electromagnetic lock 12 usually operates in conjunction with an iron plate (not shown) for implementing the lock state. Also, in practice, the electromagnetic lock 12 may be placed on a door frame (not shown) while the iron plate is installed as a door board (not shown) or on a wall and door frame. In one implementation, the iron plate is placed on the other side of the door corresponding to where the electromagnetic lock 12 is installed.

The sensing module 13 stands for the core of control in the security monitoring system 1 according to the present embodiment. The sensing module 13 is used to control the supply of electric power. The sensing module 13 by default is configured to cause a small amount of maintaining current delivered to the electromagnetic lock 12, thus allowing the electromagnetic lock 12 to be usually in the lock state with less power consumption, and the sensing module 13 outputs a triggering signal after detecting a specific action signal caused by an environment change. The triggering signal may cause the full supply of the electric power from the power supply circuit 11 to be delivered to the electromagnetic lock 12 so that the electromagnetic lock 12 may be stay in the lock state with the regular power consumption. In one implementation, the sensing module 13 may be configured as being placed within, or installed outside of, a case (not shown) of the electromagnetic lock 12, and connected to the power supply circuit 11 through embedded or externally linked wires.

Furthermore, due to variations in environment factors where the security system 1 is actually placed, the sensing module 13 may be designed as one of the accelerometer (G-sensor), capacitive sensor, electromagnetic sensor, image sensor, photo sensor and pressure sensor or combinations thereof. Certainly, for those skilled ones in the art, it is apparent that the design of the sensing module 13 is by no means limited to the aforementioned configurations; any other circuit designs that are capable of generating and issuing the triggering signal upon sensing an environment change may become the implementations of the sensing module 13. Additionally, the sensing module 13, though not specifically depicted in FIG. 1, actually may be composed of, for example, a processor and at least one peripheral circuit component. It is worth noting that the power consumed in the sensing module 13 may be far less than that normally consumed by the entire security system 1. And when the sensing module 13 is an electromagnetic sensor (e.g., a touch sensor or an infrared sensor), the total power consumption can be even further reduced.

The authentication module 14 is connected to the sensing module 13 and generates an authentication signal based on an access data in order to control the sensing module 13 to pause the output of the triggering signal within a predetermined period of an access time after the generation of the authentication signal. Herein the access data is typically installed in an identification card which interacts with the authentication module 14 through a short-range transmission technology (e.g., RFID), such that the authentication module 14 can accordingly generate the authentication signal. In other words, when the authentication module 14 identifies and authenticates the identification card, the authentication module 14 may stop outputting triggering signal during the predetermined access time, which may begin after the detection of the authentication signal. More specifically, during the predetermined access time the sensing module 13 is configured not to output the triggering signal even detecting the specific action signal caused by an environment change.

The above-illustrated descriptions allow for implementation the security system 1 with power saving feature according to the present invention. The security monitoring system 1 may further include a warning unit 15, such as an alarm, a speaker, a light indicator or other equipments, and the sensing module 13 is also further configured to continue outputting the triggering signal during a predetermined period of a delay time when no longer detecting the specific action signal caused by an environment change. And the sensing module 13 may stop outputting the triggering signal until after the end of the delay time. In doing so, the present invention security system 1 may cause the electromagnetic lock 12 to remain in the lock state during the delay time and after the elapse of a delay time cause the electromagnetic lock 12 to be switched to the unlock state. The purpose of such an arrangement is essentially to hold the electromagnetic lock 12 in the lock state up to the end of delay time after disappearance of the specific action signal, and switches to the unlock state only after elapse of the delay time. Since the warning unit 15 is connected to the sensing module 13 and under control thereof, the sensing module 13 further controls the warning unit 15 to generate a warning signal during the delay time. The sensing module 13 may be configured to operate along with another electromagnetic sensor. The function of that particular electromagnetic sensor will be subsequently discussed in more detail.

Finally, since the aforementioned electromagnetic lock 12 and the iron plate may be respectively installed on the door frame and the door board, which may result in a slight gap between the door board and the door frame when the electromagnetic lock 12 is switched back to the lock state, the security system 1 may further provide a positioning component 16 for minimizing the gap between the door board and the door frame. The positioning component 16 may be a magnet, a door operator, or a steel ball latch etc.

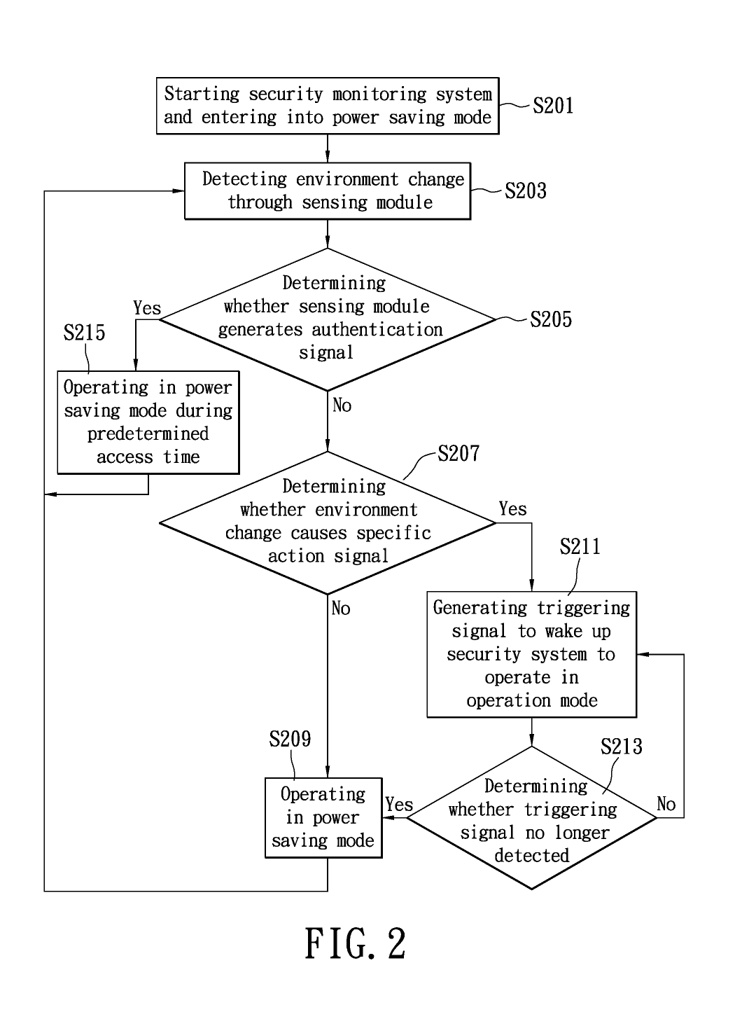

To further illustrate practical operations of the security system 1 with power saving feature according to the present invention, refer now to FIG. 2, which is a flowchart illustrating an operating method for the security system 1 shown in FIG. 1. As shown in FIG. 2, the steps of the operating method includes starting the security system 1 and causing the security system to enter into a power saving mode (S201), determining whether the sensing module 13 detects an environment change (S203) through the receipt of the action signal caused by the environment change, and causing the authentication module 14 to receive an access data before the authentication module 14 could authenticates that access data and generate an authentication signal accordingly (S205). It is worth noting that when operating in the power saving mode the security system may still operate with a maintaining current.

Suppose the determination in S205 is negative, the operation method may further determine whether the environment change detected by the sensing module 13 causes a specific action signal (S207), in which the specific action signal in design may vary from one sensing module to another sensing module adopted by the security system 1.

In case the determination in S207 is negative, indicating no matching specific action signal is detected by the sensing module 13, the operating method may cause the security system 1 to operate in a power saving mode (S209). Otherwise, when the sensing module 13 has detected the matching specific action signal caused by the environment change the operating method may cause the sensing module 13 to generate the triggering signal for switching the security system 1 from operating in the power saving mode to operating in an operation mode (S211). It should be noted that so-called “power saving mode” refers to a mode in which the security system 1 operates with the maintaining current or, in other words, with small amount of the supply of the electric power to an electromagnetic lock 12, despite the electromagnetic lock 12 may still stay in the lock state; while the “operation mode” means the security system 1 operates with the full amount of the supply of the electric power to the electromagnetic lock 12, which may continue operating in the lock state.

Subsequently, after S211 the operating method further includes determining whether the triggering signal issued by the sensing module 13 could no longer be detected (S213); when the determination in S213 is negative, indicating the specific action signal caused by the environment change is still present, the operating method thus repeats S211 allowing the sensing module 13 to continue the output of the triggering signal. When the determination in S213 is affirmative, indicating the specific action signal caused by the environment change no longer exists, the operating method thus causes the output of the triggering signal from the sensing module 13 to be stopped. And the operating method may cause the security system 1 to operate in the power-saving mode again with the limited amount of the supply of the electric power to the electromagnetic lock 12 from the power supply circuit 11 (S209).

On the other hand, suppose the determination in S205 is affirmative, meaning the authentication module 14 has authenticated the access data and generated the authentication signal, the operating method may cause the sensing module 13 to stop the output of the triggering signal during the predetermined access time after the reception of the authentication signal, disabling the security system 1 during the predetermined access period. In other words, during the predetermined access time, no matter the sensing module 13 detects any other matching specific action signal or not, the operating method may never cause the sensing module 13 to resume the output the triggering signal. In doing so, the security system 1 may allow the passage of goods or persons during the predetermined access time.

The method may repeat S203 and other following steps after S209 and S215.

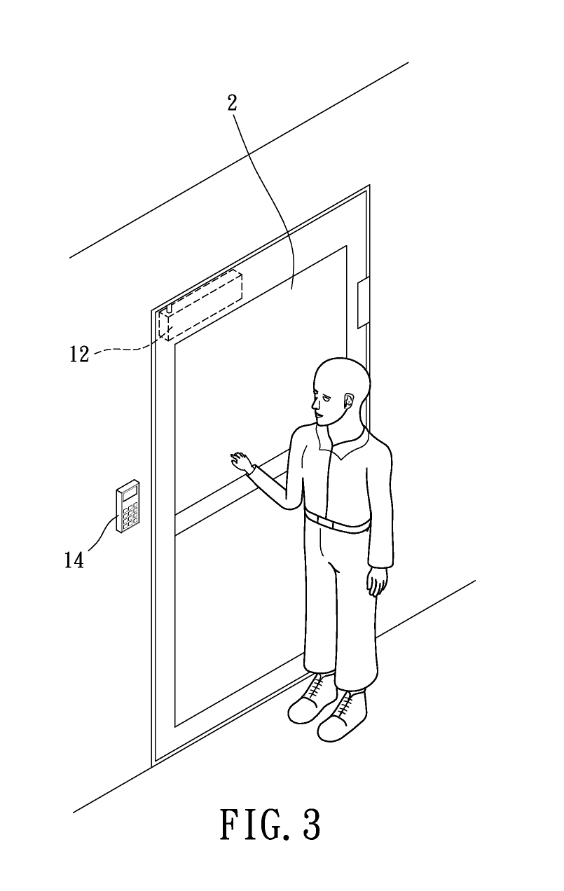

The next embodiment is presented to further exemplarily explain the configuration of the security system according to the present invention operating in conjunction with different types of sensing modules. First, refer to FIG. 3, wherein a schematic diagram illustrating the security system according to one embodiment of the present invention is shown. As shown in FIG. 3, the electromagnetic lock 12 in the security system according to the present embodiment is installed on the door board 2. And in default the electromagnetic lock 12 is in the state with the limited supply of the electric power for energy saving purpose. The sensing module cooperatively employed in the present embodiment is a so-called G-sensor and is installed inside of the electromagnetic lock 12. The G-sensor is used to provide information concerning speed and movement, in which, upon the door board 2 being touched, the G-sensor senses vibrations from the door board 2 and the acceleration associated with the door board 2, both of which may match the specific action signal of the G-sensor. The G-sensor may thus output the triggering signal. The output of the triggering signal may immediately cause the full supply of the electric power to the electromagnetic lock 12 so as to lock up the door board 2. In this way, although the electromagnetic lock 12 is usually in the power-saving mode and in the lock state, as soon as any vibration originates from the door board 2 or the acceleration associated with the door board 2 has been detected the electromagnetic lock 12 may be configured to continue operating in the lock state to block the passage of people or goods.

Additionally, the security system of the present embodiment is further conjunctively configured with an authentication module 14. So, when the identification card (not shown) having the required access data therein is sensed by the authentication module 14, the G-sensor will stop outputting the triggering signal during the predetermined access time, causing the electromagnetic lock 12 to switch to the unlock state within the access time and to enable the passage.

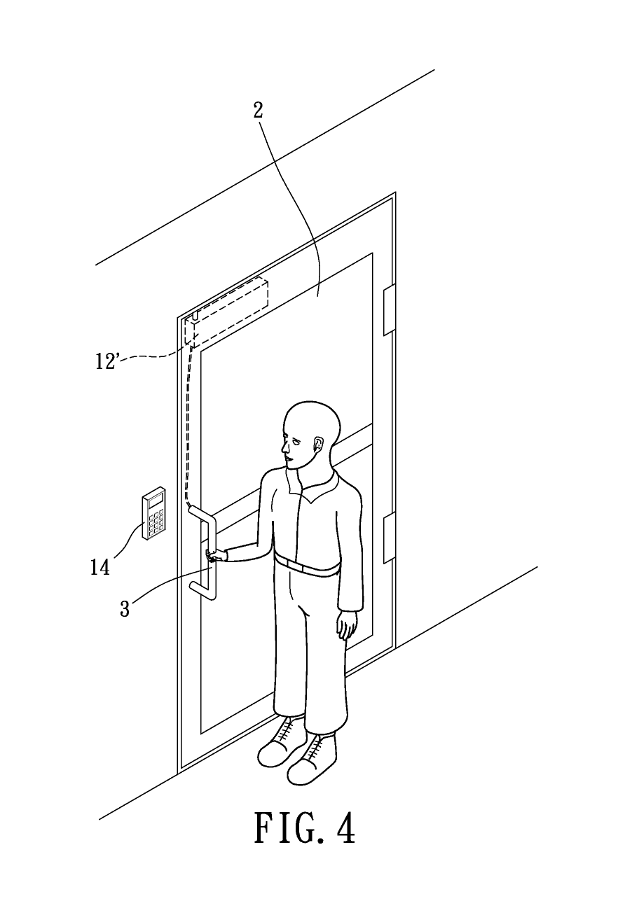

Refer to FIG. 4, wherein a schematic diagram illustrating a security system according to another embodiment of the present invention is shown. The difference between the embodiment in FIG. 4 and that in FIG. 3 is the sensing module in the embodiment shown in FIG. 4 is a capacitive sensor. In one implementation, the capacitive sensor is installed inside of the electromagnetic lock 12′. On the door board 2 is further configured with a metal door knob 3 which is electrically coupled to the capacitive sensor. The capacitive sensor is used to detect capacitance variation, which may take place as the metal door knob 3 is touched, before outputting the triggering signal. As such, the full supply of the electric power may be supplied to the electromagnetic lock 12′ to cause the electromagnetic lock 12′ to remain in the lock state for locking up the door board 2.

It should be noted that in the present embodiment the door board 2 is conjunctively installed with the metal door knob 3 in order to let the capacitive sensor to detect the capacitance variation; suppose, whereas, the door board 2 itself is made of metal, then in practice it is possible to directly connect the capacitive sensor to the door board 2 without undermining the capability of detections of capacitance variation.

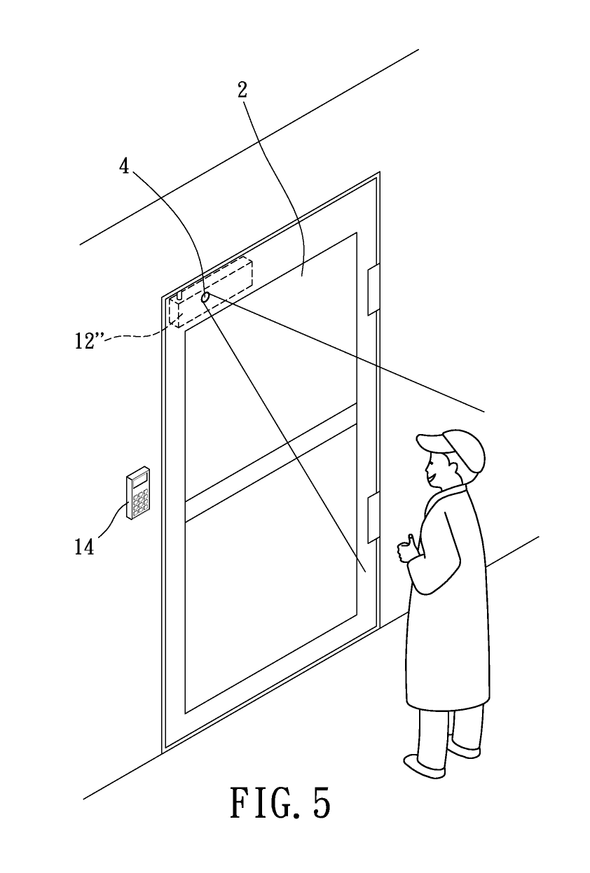

Refer subsequently to FIG. 5, wherein a schematic diagram illustrating a security system according to another embodiment of the present invention is shown. The difference between the embodiment in FIG. 5 and the aforementioned ones is the sensing module in the embodiment shown in FIG. 5 is an image sensor, which is installed inside of the electromagnetic lock 12″. The image sensor further includes a cam component 4 exposed outwardly from the electromagnetic lock 12″ for acquiring environment images. As anyone or anything approaches the door board 2 and within the imaging range of the cam component 4, the image sensor may output the triggering signal, so as to immediately cause the full supply of the electric power to the electromagnetic lock 12″, causing the electromagnetic lock 12″ to remain in the lock state for locking up the door board 2.

In summary, the security system according to the present invention can be installed in various environments and at the same time fulfills the needs for both power saving and automatic control. Additionally, according to the descriptions of the aforementioned system architecture and operating method, the present invention can be directly applied to existing systems without substantial modification by simply adding the sensing module. Furthermore, the present invention can be implemented arbitrarily in a form of software, firmware or hardware or combinations thereof, with great flexibility in use, low cost and convenient installation. Besides, the present invention is able to create various extended application functions by conjunctively installing different sensors for accommodating different types of triggering events.

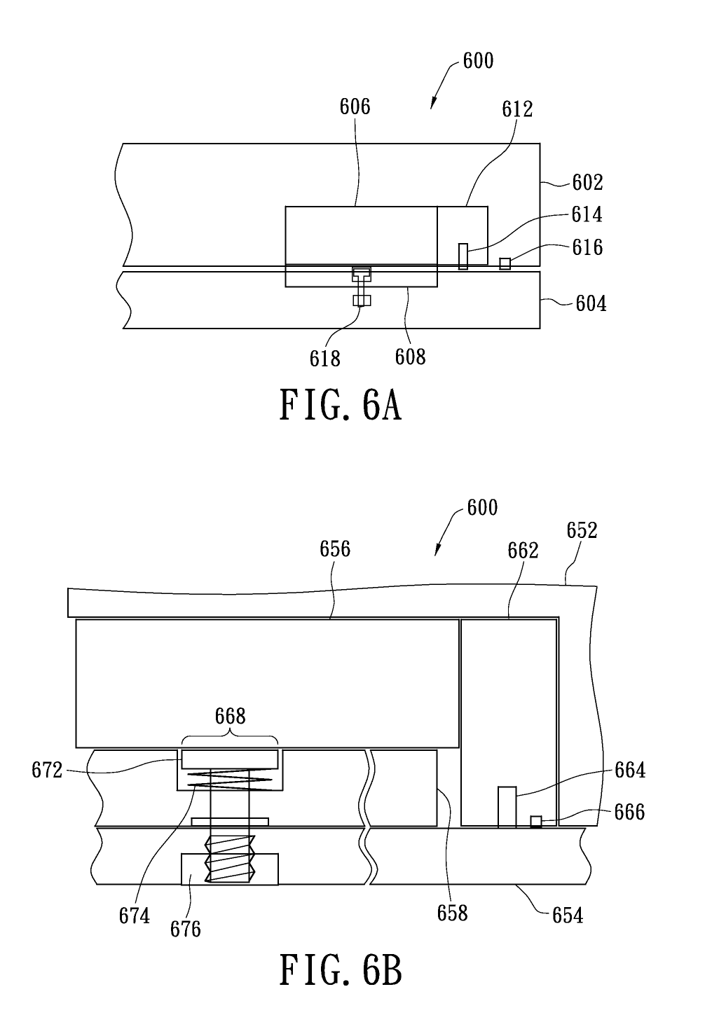

FIG. 6A is a schematic diagram illustrating a security system 600 according to another embodiment of the present invention. The security system 600 may be applicable to a door frame 602 and a door board 604. The security system 600 further includes an electromagnetic lock 606 installed on the door frame 602 and an iron plate 608 corresponding to the electromagnetic lock 606 installed on the door board 604. The security system 600 may also include a power supply circuit 612, a sensing module 614, an electromagnetic sensor 616, and a fixing means 618.

The power supply circuit 612 is configured to deliver a limited supply of the electric power to the electromagnetic lock 606 when the door board 604 is closed. The power supply circuit 612 is configured to deliver a full supply of the electric power to the electromagnetic lock 606 when the door board is to be opened for the passage after the sensing module 614 detects a specific action signal. The electromagnetic sensor 616 and the fixing means 618 may be ensuring that the door board may not be forced open as the fixing means 618 may be configured to connect the iron plate 608 and the door board 604. As previously discussed, the electromagnetic lock 606 by default is configured to operate with the limited supply of electric power, indicative of the force that may prevent any forced open without generation of an authentication signal or a triggering signal may not be sufficient enough at the first place. As such, the electromagnetic sensor 616, which could be another electromagnetic sensor with respect to the sensing module 604, is used to cause the power supply circuit 612 to deliver the full supply of the electric power to the electromagnetic lock 606. Therefore, much more force counter the forced open may be provided.

More specifically, the electromagnetic sensor 616 is configured to determine if there is any indication of the forced open by detecting the gap/distance between the iron plate 608 and the door board 604. In one implementation, when the gap/distance between the iron plate 608 and the door board 604 exceeds a predetermine threshold or such gap has been present over a predetermined period of time absent the generation of the authentication signal or the triggering signal the electromagnetic sensor 616 may inform the power supply circuit 612 of the same so that the power supply circuit 612 may deliver the full supply of the electric power to the electromagnetic lock 606.

FIG. 6B is a schematic diagram illustrating a security system 650 according to another embodiment of the present invention. Similar to the security system 600 shown in FIG. 6A, the security system 650 is also applicable to a door frame 652 and a door board 654. The security system 650 includes an electromagnetic lock 656 installed on the door frame 652, and an iron plate 658 installed on the door board 654. The security system 650 also includes a power supply circuit 662, a sensing module 664, an electromagnetic sensor 666, and a fixing means 668.

The fixing means 668 may include a screw 672, a spring 674, and a nut 676. The spring 674 may be fixed to the screw 672 integrated with the iron plate 658 and the nut 676 integrated with the door board 654. When the door board 654 is opened, the door board 654 may drive the screw 672 from its original position with respect to the iron plate 658 at the time the door board 654 is closed before the iron plate 658 moves away from its corresponding original position when the door board 654 is closed. The displacement of the screw 672 may compress the spring 674 as the door board 654 continues moving the iron plate 658 from its original position. After the iron plate 658 has been moved to a predetermined position, the resilient force associated with the compressed spring 674 may return the screw 672 to its original position with respect to the iron plate 658.

However, it should be noticed that the texts set forth hereinbefore illustrate only the detailed descriptions of the embodiments according to the present invention and appended drawings thereof, rather than for the purpose of limiting the present invention. The scope of the present invention is based on the following claims, and all modifications or alternations conveniently considered by those skilled ones in the art within the field of the present disclosure are deemed to be included in the scope of the present invention defined as the subsequent claims.

What is claimed is:

1. A security system with power saving feature, comprising:
an electromagnetic lock, which is used for receiving an electric power supplied by a power supply circuit to implement a lock state; and
a sensing module configured to cause a limited supply of the electric power to the electromagnetic lock until after detecting a specific action signal caused by an environment change at which point the sensing module is configured to output a triggering signal to cause a full supply of the electric power from the power supply circuit to the electromagnetic lock.

2. The security system with power saving feature according to claim 1, wherein the electromagnetic lock is further conjunctively configured with an attachment iron plate wherein the attachment iron plate and the electromagnetic lock are face-to-face installed.

3. The security system with power saving feature according to claim 1, further comprising:
an authentication module, which is connected to the sensing module and generates an authentication signal based on an access data so as to control the sensing module to stop an output of the trigger signal during a predetermined period of an access time after a generation of the authentication signal.

4. The security system with power saving feature according to claim 1, wherein the sensing module is further configured to continue an output of the triggering signal after no longer detecting the specific action signal for a predetermined period of a delay time and is configured to stop the output of the triggering signal after an elapse of the delay time.

5. The security system with power saving feature according to claim 4, further comprising:
a warning unit, which is connected to the sensing module and under control of the sensing module so as to generate a warning signal during the delay time.

6. The security system with power saving feature according to claim 5, wherein the warning unit is an alarm, a speaker or a light indicator.

7. The security system with power saving feature according to claim 1, further comprising:
a positioning component configured to minimizing a gap between a door board on which the electromagnetic lock is installed and a door frame.

8. The security system with power saving feature according to claim 7, wherein the positioning component is a magnet, a door operator or a steel ball latch.

9. The security system with power saving feature according to claim 1, wherein the sensing module is an accelerometer, a capacitive sensor, an electromagnetic sensor, an image sensor, a photo sensor or a pressure sensor.

10. A method for operating a security system including an electromagnetic lock, comprising
starting the security system and causing the security system to enter into a power saving mode wherein when the security system operates in the power saving mode the security system operates with a maintaining current; and
causing a sensing module to output a triggering signal based on a specific action signal caused by an environment change so as to switch the security system from the power saving mode to an operation mode.

11. The method according to claim 10, further comprising causing a limited supply of an electric power to the electromagnetic lock from a power supply circuit in order to enter the security system into the power saving mode, and causing a full supply of the electric power to the electromagnetic lock from the power supply circuit in order to enter the security system into the operation mode.

12. The method according to claim 11, after causing the output of the triggering signal from the sensing module further comprising:
causing the limited supply of the electric power to the electromagnetic lock from the power supply circuit when no the triggering signal is detected.

13. The method according to claim 11, further comprising:
causing an authentication module to authenticate an access data before the authentication module generates an authentication signal for switching the security system to operate in an unlock state for a predetermined period of an access time.

14. The method according to claim 13, further comprising causing the sensing module to stop the output of the triggering signal during the predetermined access time after a reception of the authentication signal.

15. The method according to claim 10, wherein the sensing module is an accelerometer, a capacitive sensor, an electromagnetic sensor, an image sensor, a photo sensor or a pressure sensor.
